(19) United States
(12) Patent Application Publication
(10) Pub. No.: US 2024/0336992 A1
(43) Pub. Date: Oct. 10, 2024

(54) SELECTIVE LEACHING

(71) Applicant: UMICORE, Brussels (BE)

(72) Inventors: Bart KLAASEN, Olen (BE); Jos DENISSEN, Olen (BE)

(21) Appl. No.: 18/711,909

(22) PCT Filed: Nov. 28, 2022
(86) PCT No.: PCT/EP2022/083478

§ 371 Date: May 21, 2024

(30) Foreign Application Priority Data
Nov. 30, 2021 (EP) 21211405.2

(51) Int. Cl. C22B 7/00; C22B 3/00; C22B 15/00; C22B 47/00; C25C 1/12; H01M 10/54

(52) U.S. Cl. CPC C22B 7/007; C22B 15/0067; C22B 15/0069; C22B 15/0071; C22B 23/0423; C22B 47/00; C25C 1/12; H01M 10/54

(57) ABSTRACT

The invention describes a process for the separation of Fe from Cu and one or more of Ni and Co contained in an alloyed powder having more than 1% by weight of Cu, comprising the steps of: —contacting, in oxidizing conditions, the alloyed powder with a stoichiometric amount of an acidic solution selected between a minimum suitable for dissolving 50% of all metallic elements except Fe, and a maximum suitable for dissolving 100% of all metallic elements except 50% of the Fe, thereby obtaining a leach solution containing a major part of the Cu and of the one or more of Ni and Co, and a residue containing a major part of the Fe; and, —separating the leach solution from the residue. Cu, Ni and/or Co from an alloyed powder are dissolved, while the major part of Fe is rejected to a solid residue and separated by solid/liquid separation.

The invention concerns the field of hydrometallurgy and describes a process for selectively dissolving metals such as copper, nickel or cobalt from alloys originating from battery recycling under acidic and oxidizing conditions, while rejecting iron.

Along the lifecycle of a Li-ion battery, a variety of waste and scrap materials are produced that need to be recycled because of environmental concerns, but also because of the valuable metals contained in these batteries.

The formation of waste starts already during the manufacturing of the Li-ion batteries. Due to the high quality standards and inefficiencies of the process, different parts of Li-ion batteries are rejected or scrapped in the different process steps. Along the manufacturing process, these scrapped materials can vary from off-spec cathode powders, electrode foils, combinations of anode, separator or cathode foils, battery cells without electrolyte, battery cells with electrolyte up to charged battery cells and modules. From a waste management and recycling point-of-view the complexity of these materials increases towards the end of the manufacturing process, as more and more materials are added to the product. Scrapped battery cells contain a large part of the elements in the Periodic Table, for example Ni, Co, Mn, Li, Fe, Al, V, P, F, C, Ti or Mg, in the cathode, Li, Ti, Si, C, Al or Cu, in the anode, Li, F, P or VOCs in the electrolyte, Al, Fe, Cu, Ni, Cr or plastics containing Cl or Br in the casing and many more depending on the technological developments in the Li-ion battery industry.

Besides all those Li-ion battery production wastes, also at the end of the consumer phase batteries are ending up as waste. In terms of material complexity, these end-of-life batteries are comparable to the scrapped battery cells at the end of the production process. They may be even more complex, as collection and sorting of end-of-life batteries is not 100% selective towards Li-ion batteries. This means that a Li-ion battery recycler also has to cope with minor fractions of all kinds of other batteries, such as alkaline, Ni—Cd, NiMH or Zn batteries, which can be mixed with the Li-ion batteries.

WO2020212546 describes a scheme for recovering valuable metals from spent rechargeable batteries or their scrap that starts by a pyrometallurgical smelting operation of the waste fractions. The smelting operation generates a metallic alloy containing a large portion of Ni, Co, Mn, Cu and Fe from the feed, separating these elements from impurities that are rejected into the slag. The metallic alloy fraction is then separated from the slag, transformed into a powder and further processed in a hydrometallurgical operation. After dissolution of the complete alloy in acidic conditions, Cu is first removed by cementation, which is a precipitation as metallic copper. Fe is then removed in a separate step by oxidizing with O₂ and adding Na₂CO₃ as a neutralizing agent, resulting in a Fe-precipitate.

Such an approach of sequential Cu-cementation and Fe-precipitation from Ni and/or Co containing solutions is common practice. Indeed, most Fe-removal operations rely on a precipitation of insoluble Fe³⁺ compounds at low free acid concentrations. This is, for example, explained in Monhemius et al. (The iron elephant: A brief history of hydrometallurgists' struggles with element no. 26, CIM Journal 8(4): p. 197-206, 2017). Such processes typically use a combination of oxidizing agents to promote ferrous to ferric iron conversion and basic reagents to neutralize free acid, promoting the precipitation of ferric compounds at low free acid concentrations. Common oxidizing agents are air, 02, H₂O₂, and Cl₂. Yet also stronger oxidizers can be applied, for example hypochlorite, persulfates or permanganate salts. Hydroxides or carbonates are commonly used as neutralization reagents, in particular NaOH, Na₂CO₃, Mg(OH)₂, Ca(OH)₂, CaCO₃, NH₄OH, or (NH₄)₂CO₃.

Besides Fe, many other impurities can be present in the feed solution, such as Cr, Al, As, Sb, Sn, W or Cu. These elements can be hydrolyzed and precipitated together with Fe. The hydrolysis operation uses for example sodium hydroxide, lithium hydroxide, ammonia, potassium hydroxide or calcium hydroxide. In all these cases, additional elements such as K, Ca, Na, Li, or NH4 are introduced in the solution by the neutralization reagents, which is a clear disadvantage when aiming for high-purity operations.

WO2019090389 presents an approach to avoid the introduction of additional contaminants through compounds for neutralization. As part of a flowsheet to transform a Ni metal powder feed into nickel sulfate solution, a hydrolysis is described for removal of impurities including Fe through neutralization. Ni hydroxide is used as reagent for the neutralization instead of more traditional alkali bases. It is mentioned that in particular sodium or potassium hydroxide bases are avoided as these bases typically lead to alkali contamination. The Ni hydroxide is prepared in a separate operation by precipitating Ni from a part of the refined solution using sodium hydroxide. In this way, sodium does not enter the main flow of the operation, but the consumption of sodium hydroxide remains. Despite the use of a Ni-containing metallic feed in the main flow, the additional installation for making Ni hydroxide makes this essentially a two-step process.

Another approach to separate Ni and/or Co from impurities that co-exist in the feed is by selective leaching of the feed. Selected impurities are dissolved to a lesser extent or these selected impurities are preferentially rejected into a solid residue. This is for example described in WO2019064996, where battery alloys are subjected to a leaching operation in the presence of a sulfurization agent, this way preferentially dissolving Ni, Co and Fe while leaving most of the Cu in the residue, which is then separated from the other elements by solid/liquid filtration. WO2019102765 presents a different approach based on electro-leaching of alloys from battery smelting (“battery alloys”) to selectively dissolve Ni, Co and Fe from these alloys while electrodepositing Cu onto a cathode. In this way, Cu is separated during leaching of the battery alloy, avoiding that a large part of Cu from the feed ends up in the leaching solution.

The above-cited documents highlight different ways of leaching alloys. All have in common that Fe contained in those alloys is completely dissolved together with other metals. Hence, separation of the major part of Fe from other dissolved metals in the feed requires a separate downstream treatment of the leach liquor.

In traditional schemes for processing alloyed powder, Fe is first dissolved in a leaching operation and subsequentially removed from solution in a downstream Fe removal. For example, when leaching alloyed powder using H₂SO₄, Fe is first dissolved as FeSO₄ during leaching according to the reaction:

Fe+H₂SO₄+½O₂→FeSO₄+H₂O.

Subsequently it is oxidized and precipitated, for example as FeOOH during Fe removal according to:

2FeSO₄+H₂SO₄+½O₂→2Fe₂(SO₄)₃+H₂O and Fe₂(SO₄)₃+4H₂O→2FeOOH(s)+3H₂SO₄.

Acid released during the precipitation of Fe is typically neutralized, for example using Ca(OH)₂ or NaOH and transformed into CaSO₄ or Na₂SO₄ salts:

H₂SO₄+Ca(OH)₂→CaSO₄+2H₂O or H₂SO₄+2NaOH→Na₂SO₄+2H₂O.

In such a traditional scheme, Fe first consumes a stoichiometric amount of acid during leaching. In the subsequent Fe removal operation, this acid is neutralized with caustic compounds such as carbonates or hydroxides of Na, K, Mg, Ca, Li, or ammonia. The reaction products are often ammonium salts, alkali salt or earth-alkali salt. These reaction products can end up in the product solution, introducing additional impurities like Na, K, Mg, Ca, Li, NH₄. Alternatively, these reaction products can end up in the Fe residue, introducing additional impurities and increase the mass of this residue, which is often considered as a waste product.

The present invention discloses a process for dissolving Ni and/or Co and Cu from a metallic battery alloy, while preventing that Fe contained in such an alloy is also completely dissolved. Instead, a portion of this Fe is rejected to a solid residue and separated by solid/liquid separation.

Key of the process is the use of an alloyed powder containing Cu and one or more of Ni and Co, which has reducing properties, in combination with the use of an oxidizing agent, all in a single operation. Cu and Fe are separated. The presented process thus advantageously combines materials and reaction conditions typically not used, or not used in combination. The introduction of additional impurities into the process is restricted or even completely avoided.

A first embodiment describes a process for the separation of Fe from Cu and one or more of Ni and Co contained in an alloyed powder having more than 1% by weight of Cu, comprising the steps of:
contacting, in oxidizing conditions, the alloyed powder with a stoichiometric amount of an acidic solution selected between a minimum suitable for dissolving 50% of all metallic elements except Fe, and a maximum suitable for dissolving 100% of all metallic elements except 50% of the Fe, thereby obtaining a leach solution containing a major part of the Cu and of the one or more of Ni and Co, and a residue containing a major part of the Fe; and,
separating the leach solution from the residue.

By “alloyed powder” is meant a metallic alloy, i.e. a mixture of zero-valent metals, in form of a powder. The alloyed powder should preferably comprise a total of Cu, Co, Ni, Mn and Fe of more than 90% by weight, and more preferably of 95% or even of 98%. In practice, alloys can contain other elements as impurities, in particular oxygen, introduced during the production process or afterwards by contact with the surrounding. This is particularly relevant when a fine-sized powder is produced and/or handled in without an inert atmosphere, possibly resulting in considerable oxidation of the reactive powder. The alloyed powder preferably comprises at least 25% by weight of the total of Co and Ni The alloyed powder preferably comprises at least 1% by weight of Fe, as an upfront separation during leaching makes industrially no sense below that limit. This alloyed powder can be a mixture of particles with different individual composition. In this case, when referring to compositions, we mean the average composition over all particles.

The amount of acidic solution is termed “stoichiometric” because it can be derived from the stoichiometry of the involved dissolution reactions. This assumes that the composition of the alloy is at least approximately known, which is typically the case in industrial practice.

The present process can be optimized by selecting an alloyed powder containing the elements Ni and/or Co, which dissolve at least partially and thereby upgrade the value of the solution.

Unlike in traditional schemes, no neutralization reagents are used in the present process. Hence no dilution of the product solution is caused by the introduction of neutralization reagents. Also, the cost associated to the use of caustic compounds that are typically used as neutralization reagents is avoided.

Unlike in traditional schemes, no caustic compounds such as hydroxides of Na, K, Mg, Ca, Li, or ammonia are used in the present process. Hence no additional impurities are introduced in the solution. This eliminates the need for downstream operations to separate such impurities like Na, K, Mg, Ca, Li, NH₄ from the valuable elements like Co and/or Ni.

Unlike in traditional schemes, Fe does not consume acid during the leaching operation. Hence the optimized process achieves the best-possible use of acid from a leaching operation and of acid generated in the process. Such acid is used for the dissolution of additional Cu, Ni and/or Co present in the alloyed powder.

Unlike in traditional schemes, in the current process Fe is not first dissolved during leaching and subsequently removed in a separate unit operation. Instead, a major part of Fe is not dissolved during leaching. The inventors have found that this allows to increase the concentration of other metals in the leaching solution. In order to avoid undesired precipitation and scaling of solids when handling leach solutions, the total concentration of elements in solution after leaching should not exceed their maximal combined solubility. Because a major part of Fe is not dissolved, Fe concentrations in solution after leaching are lower in the present process compared to a traditional scheme in which most or all Fe is dissolved. Consequently, higher concentrations of other elements can be targeted without exceeding the maximal combined solubility of all elements in solution. This can be achieved by increasing the amount of alloyed powder per volume in the leaching operation. Because more alloy per volume can be processed, this allows to decrease the reactor size for a given capacity of alloyed powder. It also reduces the volumetric flow of product solution which allows to reduce the footprint or increases the capacity of downstream unit operations.

The presence of at least a minimum amount of Cu is essential. Already a concentration of at least 1% of Cu in the alloy, has been found to be a suitable minimum for achieving a commercially viable process. It is indeed assumed that Cu has a catalytic effect in the current process.

In a further embodiment, the alloyed powder also contains Mn.

By “major part” of an element is meant 50% or more by weight of the amount of that element entering the process.

In a further embodiment according to the first embodiment, the stoichiometric amount of acidic solution in the step of contacting is determined to dissolve all metallic elements except Fe.

This amount is however rather theoretical. In practice, the desired elements do not dissolve quantitatively, and Fe unavoidably dissolves to a limited extend. The amount of acid defined as a lower limit allows to minimize the dissolution of Fe, while ensuring the dissolution of a major part of the Ni, Co, Mn, and Cu. The amount defined as an upper limit allows to optimize the dissolution yield of Ni, Co, Mn, and Cu, while keeping a major part of the Fe in the residue.

While dissolving at least 50% of all metallic elements except Fe is acceptable, it is preferred to dissolve much higher amounts of the valuable metals, such as at least 90%, 95%, or even 98% of them.

On the other hand, the present process limits the amount of acid to dissolve not more than 50% of Fe, preferably not more than 25% of Fe, and even more preferred not more than 10% of Fe.

This way, the present process allows to separate the major part of the Fe from the other valuable metals without the need to first dissolve it completely. This advantageously reduces the amount of acid needed in the process and at the same time avoids follow-up operations to treat Fe in solution. The examples below illustrate excellent leaching yields especially for Co and Ni, but also for Cu, while minimizing the amount of Fe in solution.

In a further embodiment, the alloyed powder originates from the recycling of Li-ion batteries or their waste using a pyrometallurgical smelting process.

Battery alloys, particularly when originating from pyrometallurgically processed Li-ion batteries or their waste, are considered to contain Cu and one or more of Ni and Co. This way the required minimum concentration of Cu is always present, while especially the value of Ni and/or Co makes the process industrially interesting.

Li-ion batteries or their waste comprise new or waste Li-ion batteries, spent or end-of-life batteries, production or battery scrap, battery constituents, such as electrode foils, electrolytes, separators, casing material and electrode materials, or pre-processed battery materials, resulting in very complex waste streams. Key metals in such waste streams are typically copper, nickel and/or cobalt, which end up in an alloy when pyrometallurgically processed.

In a further embodiment, the alloyed powder is obtained by comminution or atomization.

In comparison with traditional schemes which target a full dissolution of the alloy, the amount of acid added in the present process is more limited. As a result, the average acidity during the leaching process is lower. Consequently, process conditions are mild. Nevertheless, the inventors have surprisingly found that alloyed powders comprising Cu and one or more of Ni and Co, are sufficiently reactive to dissolve under these mild conditions, with high dissolution yields for Cu, Ni and/or Co. Such powders can be obtained by comminution or atomization, in particular by milling or spray atomization, for example water jet atomization. This is in contrast to large particles like granules or other large chunks of alloy that are not efficiently usable in the current process due to their lower reactivity, which is explained by a lower specific surface.

The use of alloy powders also allows processing in common stirred reactors. Such reactors enable good process kinetics by full or partial suspension of the powder to facilitate mass and energy transfer. Also these reactors allow a good dispersion of oxidizing agents, both when using gaseous reagents like oxygen or liquid reagents like hydrogen peroxide.

In a further embodiment, the alloyed powder has a particle size distribution having a D90 below 800 μm, and/or a D50 below 300 μm.

The D50 and D90 refer to a distribution by number. The particle size distribution of the alloyed powder is determined by laser diffraction. Laser diffraction can be performed according to ISO 13320:2020. Particles with a D90 above 800 μm, and/or a D50 above 300 μm require more mixing power for suspension in a stirred reactor. This increases energy consumption and wear of the installation, making such coarser powders less preferable in the process.

In a further embodiment, the acid in the acidic solution is either H₂SO₄ or HCl.

While theoretically also possible with other acids, using either H₂SO₄ or HCl is preferred. Many hydrometallurgical flowsheets are based on either of the two, allowing to easily integrate the present process in existing operations.

In a further embodiment, the contacting step is performed in stages according to:
mixing the alloyed powder with a first amount of acidic solution, corresponding to 50% to 95% of the selected stoichiometric amount, thereby obtaining a suspension comprising a liquid phase and a solid phase;
oxidizing the suspension; and,
acidifying the suspension with a second amount of acidic solution, whereby the sum of said first and second amount corresponds to 100% of the determined stoichiometric amount.

The first amount of acid can be added rather fast, saving time, as a precise determination ensures adding a relatively large, but still under-stoichiometric part of the determined total amount of acid. The second amount of acid, typically smaller than the first amount, is then added slower to achieve a better process control. This embodiment is therefore an efficient multistage process.

In-between the addition of the first amount of acidic solution and the second amount of acidic solution, oxidizing conditions are maintained. During this intermediate step, the metals in the suspension will continue to oxidize and the suspension will evolve towards a thermodynamic equilibrium. Consequently, less metals need to be oxidized in the second addition step. The kinetics of metal dissolution in the second addition step are less limited by the oxidation reaction, which is typically the reaction with the lowest reaction rate. The intermediate equilibration allows for a faster system response during the second addition, enabling a more accurate process control when adding acid.

A further embodiment describes a process for the separation of Fe from Cu and one or more of Ni and Co contained in an alloyed powder having more than 1% by weight of Cu, comprising the steps of:
contacting, in oxidizing conditions, the alloyed powder with a stoichiometric amount of an acidic solution suitable for dissolving at least 50% of all metallic elements except Fe, and for dissolving at most 100% of all metallic elements except 50% of the Fe, thereby obtaining a leach solution containing a major part of the Cu and of the one or more of Ni and Co, and a residue containing a major part of the Fe, wherein the acid in the acidic solution is H₂SO₄, and wherein the contacting step is performed in stages according to:
determining a stoichiometric amount of the acidic solution to dissolve 100% of all metallic elements except Fe;
mixing the alloyed powder with an amount of the acidic solution corresponding to 50% to 100% of the determined stoichiometric amount, thereby obtaining a suspension comprising a liquid phase and a solid phase;
oxidizing the suspension at a temperature of more than 50° C. to a redox potential of more than 320 mV Ag/AgCl;
with the proviso that the Fe concentration in the liquid phase is below 0.5 g/L, acidifying the suspension at a temperature of more than 50° C. in oxidizing conditions by adding acidic solution until the Fe concentration is between 0.5 g/L and 3 g/L; and
with the proviso that the pH of the liquid phase is above 3, acidifying the suspension at a temperature of more than 50° C. in oxidizing conditions by adding acidic solution until the pH is between 1.5 and 3; and,
separating the leach solution from the residue.

By “determining a stoichiometric amount” of the acidic solution is meant a physical or mental act for evaluating the amount of acid needed for the dissolution of:
at least 50% of all metallic elements in the alloy, except Fe; and,
at most 100% of all metallic elements in the alloy, except 50% of the Fe. Or, in other words, at most 100% of all non-iron metals in the alloy, plus half of the iron.

A physical act could encompass the chemical analysis of a sample of the alloy. A mental act could be an evaluation based on experience with a similar alloy, a calculation or any other estimation of the approximate required stoichiometry. The calculation or estimation can be based on the assumption that the metallic elements in the alloy dissolve as bivalent cations. The following reactions show the stoichiometry when using either sulfuric or hydrochloric acid: M+H₂SO₄+½O₂→MSO₄+H₂O, or M+2 HCl+½ O₂→MCl₂+H₂O, wherein M is Ni, Co, Mn, Cu and Fe.

This embodiment is preferred, as the second amount of acid can be more precisely dosed by monitoring the pH and/or the dissolved Fe. This is particularly useful when the composition of the starting material is not precisely known.

In the present process, the addition of the first amount of acid is performed at a temperature of more than 50° C. A higher temperature, such as 60° C. or 70° C., is beneficial for reaction kinetics, speeding up the process. Depending on the characteristics of the reactor, the temperature can increase during the leaching as a result of heat produced by the dissolution reactions, which are exothermic.

In a preferred embodiment, the addition of a second amount of acid according to any provisio above is performed at a temperature of more than 75° C. Also in this step, a higher temperature is beneficial for reaction kinetics, speeding up the process.

The first proviso advantageously addresses a situation in which the concentration of Fe in solution is very low. At a concentration below 0.5 g/L Fe, the inventors found that not enough of the alloyed powder has been dissolved, resulting in lower dissolution yields for valuable elements like Ni and Co. Acidifying will dissolve some Fe, but most of all enhance the leaching yield of Cu, Co and/or Ni. The upper limit of 3 g/L Fe helps to avoid acidifying too much.

The second proviso advantageously addresses a situation in which the pH of the solution is too high. At a pH above 3, increasing amounts of Cu, Co and/or Ni are observed in the residue, resulting in unacceptable losses of these valuable metals. A lower pH limit of 1.5 helps to avoid acidifying too much, which would result in dissolving too much or all of the Fe.

The staged addition according to any one proviso above allows for faster and more precise process control. Adding all of the acid in a single stage, bears the risk of dosing too much acid and dissolving too much of the Fe.

Equilibration starts with mixing the first quantity of acidic solution with the alloyed powder and continues during every consecutive addition. Consecutive additions of acidic solution minimize the risk of dosing too much acid, but costs more time. The present process is also designed to find the balance between a fast addition of a first amount of acidic solution (preferably close to stoichiometric with regards to all metallic elements except Fe), saving time, while avoiding to dose too much acid, resulting in the dissolution of too much Fe.

By “the acid in the acidic solution is H₂SO₄” is meant that the major part of the acid in the used acidic solution is H₂SO₄. This does therefore not exclude operations in which a small portion of another acid, such as HCl or HNO₃, is also present in solution. In such cases, any other acid present in solution also has to be taken into account when determining the stoichiometric amount.

In a further embodiment, the acid in the acidic solution is HCl, and the contacting step is performed in stages according to:
determining a stoichiometric amount of the acidic solution according to the first embodiment;
mixing the alloyed powder with an amount of the acidic solution corresponding to 50% to 100% of the determined stoichiometric amount, thereby obtaining a suspension comprising a liquid phase and a solid phase;
oxidizing the suspension at a temperature of more than 50° C. to a redox potential of more than 320 mV Ag/AgCl; and,
with the proviso that the pH of the liquid phase is above 2, acidifying the suspension at a temperature of more than 50° C. in oxidizing conditions by adding acidic solution until the pH is between 0.5 and 2.

While H₂SO₄ is probably more frequently used in industry, HCl has the same advantages and therefore is an equally preferred choice. The inventors have observed that the selectivity in dissolving metals is typically even somewhat better when using HCl. It has also been observed that under the present process conditions the Fe concentration in the leach solution is very low, rendering a provisio for the Fe concentration mostly useless. For this embodiment therefore only the provisio for pH is applied.

The pH range when using HCl is lower (i.e. more acidic) than for H₂SO₄.

By “the acid in the acidic solution is HCl” is meant that the major part of the acid in the used acidic solution is HCl. This does therefore not exclude operations in which a small portion of another acid, such as H₂SO₄ or HNO₃, is also present in solution. In such cases, any other acid present in solution also has to be taken into account when determining the stoichiometric amount.

The choice for using HCl or H₂SO₄ leads to two independent embodiments.

In a further embodiment, the oxidizing conditions in the contacting step are obtained by addition of H₂O₂ and/or an O₂-bearing gas. The use of air is possible, but will result in lower process kinetics compared to the use of O₂ gas.

In a further embodiment, the process is performed at atmospheric pressure. Leaching under elevated pressure is not required, avoiding the use of more expensive autoclaves.

In a further embodiment, the acidic solution in the contacting step is obtained by acidic leaching of a solid starting material containing Ni and/or Co. These elements will end up in the leach solution together with the metals introduced through the alloy powder that is dissolved. While also Fe can be present in this acidic solution, the Fe concentration is preferably less than 3 g/L, preferably less than 2 g/L, more preferably less than 1 g/L. If lesser Fe is present in the starting solution, more Fe dissolution from the alloyed powder can be accepted. Allowing more Fe dissolution from the alloyed powder can be beneficial to maximize dissolution yields for Ni, Co and/or Cu.

In a further embodiment, the alloyed powder and the solid starting material have the same composition. This preferred setup helps to avoid the introduction of further impurities, while contributing to the overall output of pure valuable metals such as Ni and/or Co. This covers processing schemes in which the solid starting material is the same alloyed powder. In such a scheme, the acidic starting solution can originate from a recycle stream from a unit operation downstream of the leaching operation. Optionally, Fe can be removed from this recycle stream before using it as an acidic starting solution in the leaching operation, in order to limit the Fe concentration in the starting solution.

In a further embodiment, the steps of mixing, oxidizing and acidifying are operated sequentially as continuous processes.

Compared to batch wise processes, such continuous processes allow to increase process intensity in an industrial setup.

In a further embodiment, the leach solution, obtained in the step of separating the leach solution from the residue, is further treated in an electrowinning step to separate Cu from other metals contained in said solution, particularly from Ni and/or Co.

Electrowinning can, for example, be performed directly on the leach solution (“direct EW”) or be combined with solvent extraction (“SX-EW”).

In a further embodiment, the residue, obtained in the step of separating the leach solution from the residue, is used as a starting material for steel-making.

The following examples illustrate the invention.

### EXAMPLE 1

This example illustrates an embodiment using a 2-staged addition of sulfuric acid. The second addition is triggered by the pH-related criterion.

A CoNiCuFeMn-alloy originates from a battery smelting process. It is converted into a powder by atomization. The particle size distribution is measured with laser diffraction: the mean particle diameter has a D50 of 96 μm, and a D90 of 298 μm.

The elemental composition by weight is: 59% Co, 9.5% Ni, 0.3% Mn, 25% Cu, and 5.1% Fe.

252 g of this alloyed powder is added to a beaker together with 1.4 L of demineralized water. Upon mixing, a suspension forms, which is heated to 65° C. 02 is sparged through the suspension at 75 L/h.

The stoichiometric amount of acid to dissolve all metallic elements except Fe is determined to be 3.93 mol of H₂SO₄. This can be directly derived from Table 1a. This corresponds to 772 mL of an aqueous acidic solution containing 500 g/L of H₂SO₄.

TABLE 1a
Determination of the stoichiometric
amount of sulfuric acid

| | Mass | | Stoichiometric |
|---|---|---|---|
| Element | (g) | Mol | H₂SO₄ (mol) |
| Co | 149 | 2.52 | 2.52 |
| Ni | 24 | 0.41 | 0.41 |
| Mn | 1 | 0.01 | 0.01 |
| Cu | 63 | 0.99 | 0.99 |
| Fe | 13 | 0.23 | 0.23 |

It is selected to add 69% of the above-determined amount to the suspension. This corresponds to 530 mL of aqueous acidic solution. The solution is slowly added, over a period of 3 h, while sparging.

The temperature is then increased to 82° C., while sparging is continued. The redox-potential climbs to 326 mV Ag/AgCl, and the pH to 4.03. Liquid is sampled and the Fe concentration is measured to be 0.6 g/L.

This Fe level is not below the threshold of 0.5 g/L: further acidification is thus not triggered by the Fe-related criterion.

The pH is above the threshold of 3: this triggers the need for further acidification according to the pH-related criterion. A pH between 1.5 and 3 is targeted.

A further amount of aqueous acidic solution is therefore slowly added to the suspension, over a period of 3 h, at a temperature of 80° C. while sparging 02 through the suspension at 75 L/h. The process step is assumed to be terminated when the pH stabilizes at 2.7. A further amount of 250 ml of acidic solution has then been added.

In total, 780 mL of 500 g/L H₂SO₄ solution has been used. This is an amount of an acidic solution suitable for dissolving at least 50% of all metallic elements except Fe and corresponds to the stoichiometric amount suitable for dissolving 98% of all metallic elements except 50% of the Fe.

Next, the solid and liquid fractions are separated by filtration. 2.0 L of leach solution is obtained. The residue weighs 67.2 g with a moisture content of 62%. Both compositions are shown in Table 1b, together with the leach yield that is calculated as the mass of an element contained in the liquid divided by the sum of the amounts of the element contained in the filtrate and the solids.

TABLE 1b
Composition of solid residue and leach solution

| | Composition | Composition solids | Leach yields |
|---|---|---|---|
| Element | liquid (g/l) | on a dry basis (%) | (%) |
| Co | 75 | 0.4 | >99 |
| Ni | 12 | 0.1 | >99 |
| Mn | 0.3 | 0.4 | 86 |
| Cu | 30 | 4.6 | 98 |
| Fe | 1.8 | 36 | 28 |

This example shows how nearly all Co, Ni, Mn and Cu can be dissolved with high yields, while 72% of the Fe reports to the residue. The residue contains only traces of the most valuable metals Co and Ni.

### EXAMPLE 2

This example illustrates an embodiment using a single addition of sulfuric acid. Neither is a further acidification triggered by the Fe-related criterion, nor by the pH-related criterion.

A CoNiCuFeMn-alloy originates from a battery smelting process. It is converted into a powder by atomization. The particle size distribution is measured with laser diffraction: the mean particle diameter has a D50 equal to 102 μm and a D90 equal to 274 μm.

The elemental composition by weight is: 32% Co, 12% Ni, 2.3% Mn, 26% Cu, and 26% Fe. 5543 g of the alloy powder is added to a 60 l reactor together with 38 L of demineralized water. Upon mixing, a suspension forms, which is heated to 60° C. 02 is sparged through the suspension at 400 L/h.

The stoichiometric amount of acid to dissolve all metallic elements except Fe is determined to be 66.45 mol of H₂SO₄. This can be derived from Table 2a. This corresponds to 4.90 L of an aqueous acidic solution of 1330 g/L H₂SO₄.

TABLE 2a
Determination of the stoichiometric
amount of sulfuric acid for Example 2

| | Mass | | Stoichiometric |
|---|---|---|---|
| Element | (g) | Mol | H₂SO₄ (mol) |
| Co | 1774 | 30.1 | 30.1 |
| Ni | 665 | 11.3 | 11.3 |
| Mn | 127 | 2.32 | 2.32 |
| Cu | 1441 | 22.68 | 22.68 |
| Fe | 1441 | 25.8 | 25.8 |

It is selected to add 99% of the above-determined amount to the suspension. This corresponds to 4.85 liter of aqueous acidic solution. The solution is slowly added, over a period of 4.5 h, while sparging.

After adding the aqueous acidic solution, the redox-potential in the suspension is measured to be 216 mV vs Ag/AgCl and a pH of 1.6 is measured.

Next, the temperature is increased to 80° C., while sparging is continued. The redox-potential climbs to 340 mV vs Ag/AgCl and the pH to 2.9. Liquid is sampled and the Fe concentration is measured to be 1.9 g/l.

The pH is not above the threshold of 3.0 and the Fe level is not below the threshold of 0.5 g/l. This means that further acidification is not triggered by the Fe-related criterion nor by the pH-related criterion. Hence no additional acidic solution is added. This means that in total 4.85 l of 1330 g/L H₂SO₄ solution is consumed. This corresponds to the stoichiometric amount suitable for dissolving 83% of all metallic elements except 50% of the Fe.

Next, the solid and liquid fractions are separated by filtration. 35 L of leach solution is obtained. The residue weighs 9387 g with a moisture content of 69%. Both compositions are shown in Table 2b, together with the leach yield that is calculated as the mass of an element contained in the liquid divided by the sum of the amounts of the element contained in the filtrate and the solids.

TABLE 2b
Composition of solid residue and leach solution for Example 2

| | Composition | Composition solids | Leach yields |
|---|---|---|---|
| Element | liquid (g/l) | on a dry basis (%) | (%) |
| Co | 50 | 0.3 | >99 |
| Ni | 19 | 0.1 | >99 |
| Mn | 3.2 | 0.4 | 91 |
| Cu | 38 | 3.2 | 94 |
| Fe | 1.9 | 48 | 4.5 |

This example shows how nearly all Co, Ni, Mn and most Cu can be dissolved while 95% of the Fe reports to the residue. In comparison with example 1, no second addition of acid is required, as neither the claimed provisio for Fe in solution nor the provisio for pH is triggered.

### EXAMPLE 3

This example illustrates an embodiment using a 2-staged addition of sulfuric acid. The second addition is triggered by the Fe-related criterion.

A CoNiCuFeMn-alloy originates from a battery smelting process. It is converted into a powder by atomization. The particle size distribution is measured with laser: the mean particle diameter has a 050 equal to 143 μm, and a 090 equal to 296 μm.

The elemental composition by weight is: 19% Co, 44% Ni, 7.8% Mn, 22% Cu, and 5.8% Fe. 4638 g of the alloy powder is added to a 60 l reactor together with 42 L of demineralized water. Upon mixing, a suspension forms, which is heated to 60° C. 02 is sparged through the suspension at 350 L/h.

The stoichiometric amount of acid to dissolve all metallic elements except Fe is determined to be 72.37 mol of H₂SO₄. This can be directly derived from Table 3a. This corresponds to 5.33 liter of an aqueous acidic solution containing 1330 g/L of H₂SO₄.

TABLE 3a
Determination of the stoichiometric
amount of sulfuric acid for Example 3

| | Mass | | Stoichiometric |
|---|---|---|---|
| Element | (g) | Mol | H₂SO₄ (mol) |
| Co | 881 | 15.0 | 15.0 |
| Ni | 2041 | 34.8 | 34.8 |
| Mn | 362 | 6.6 | 6.6 |
| Cu | 1020 | 16.1 | 16.1 |
| Fe | 269 | 4.8 | 4.8 |

It is selected to add 90% of the above-determined amount to the suspension. This corresponds to 4800 mL of aqueous acidic solution. The solution is slowly added, over a period of 5.5 h, while sparging.

After adding the aqueous acidic solution, the redox-potential in the suspension is measured to be 370 mV vs Ag/AgCl and the pH is measured to be 0.5. Liquid is sampled and the Fe-concentration in the liquid at this point is measured to be 5.5 g/L.

The temperature is then increased to 80° C., while sparging is continued. Liquid is sampled and the Fe-concentration is monitored every hour. After 10 h, the Fe-concentration is measured to be 0.42 g/L.

This Fe level is below the threshold of 0.5 g/L: this triggers the need for further acidification according to the Fe-related criterion. An Fe concentration of 2.5 g/l is targeted.

A further amount of aqueous acidic solution is therefore slowly added to the suspension, over a period of 4 h, at a temperature of 80° C. while sparging 02 through the suspension at 350 L/h. The process step is assumed to be terminated when the targeted Fe concentration of 2.5 g/l is reached.

A further amount of 570 ml of acidic solution has then been added. At this point, the pH is measured to be 2.0.

In total, 5370 mL of 1330 g/L H₂SO₄ solution has been used. This corresponds to a stoichiometric amount suitable for dissolving 101% of all metallic elements except Fe. This also corresponds to the stoichiometric amount suitable for dissolving 97% of all metallic elements except 50% of the Fe.

Next, the solid and liquid fractions are separated by filtration. 42 liter of leach solution is obtained. The residue weighs 3408 g with a moisture content of 86%. Both compositions are shown in Table 3b, together with the leach yield that is calculated as the mass of an element contained in the liquid divided by the sum of the amounts of the element contained in the filtrate and the solids.

TABLE 3b
Composition of solid residue and leach solution for Example 3

| | Composition | Composition solids | Leach yields |
|---|---|---|---|
| Element | liquid (g/l) | on a dry basis (%) | (%) |
| Co | 20 | 0.7 | >99 |
| Ni | 47 | 0.9 | >99 |
| Mn | 8.4 | 0.4 | >99 |
| Cu | 23 | 2.3 | 99 |
| Fe | 2.5 | 35 | 39 |

This example shows how nearly all Co, Ni, Mn and Cu can be dissolved with high yields, while 61% of the Fe reports to the residue. The residue contains only traces of the most valuable metals Co and Ni.

### EXAMPLE 4

This example illustrates a different approach for the addition of acidic solution.

A CoNiCuFeMn-alloy originates from a battery smelting process. It is converted into a powder by atomization. The particle size distribution is measured with laser diffraction: the mean particle diameter has a D50 of 162 μm, and a D90 of 458 μm.

The elemental composition by weight is: 38% Co, 9% Ni, 2.2% Mn, 22% Cu, and 27% Fe.

250 g of this alloyed powder is added to a beaker together with 1.7 L of demineralized water. Upon mixing, a suspension forms, which is heated to 75° C. 02 is sparged through the suspension at 75 L/h.

The stoichiometric amount of acid to dissolve all metallic elements except Fe is not determined upfront. Instead a pH measurement in the liquid is used for controlling acid addition with a simple feedback loop that maintains a pH below 2.0. Hence when the pH drops below this setpoint of pH 2.0, acid addition is interrupted. The addition of acid only resumes when the pH increases again above the setpoint of pH 2.0. This increase of pH is explained by free acid consumption during dissolution of alloy powder.

Using this approach, a diluted sulfuric acid solution (500 g/L H₂SO₄) is slowly added to the suspension, over a period of 6 h, at a temperature of 75° C. while sparging 02 through the suspension at 75 L/h. The process step is assumed to be terminated when the pH stabilizes at 2.0 without adding more acid.

At this point, 688 ml of the 500 g/L H₂SO₄ solution has been added. The redox potential in the suspension is 396 mV vs Ag/AgCl. Liquid is sampled and the Fe concentration is measured to be 18 g/l.

The temperature is then increased to 85° C., while sparging is continued. The pH decreases despite the fact that no more acid is added. After 5 hours, the pH in the liquid is 1.4.

At this point the solid and liquid fractions are separated by filtration. 2.2 L of leach solution is obtained. The residue weighs 167 g with a moisture content of 49%. Both compositions are shown in table 4a, together with the leach yield that is calculated as the mass of an element contained in the liquid divided by the sum of the amounts of the element contained in the filtrate and the solids.

TABLE 4a
Composition of solid residue and leach solution for Example 4

| | Composition | Composition solids | Leach yields |
|---|---|---|---|
| Element | liquid (g/l) | on a dry basis (%) | (%) |
| Co | 42 | 0.2 | >99 |
| Ni | 10 | 0.4 | 99 |
| Mn | 2.4 | 0.3 | 95 |
| Cu | 24 | 0.7 | 99 |
| Fe | 11 | 51 | 36 |

In this example the use of a pH based controller for adding acid resulted in the addition of 688 ml of a 500 g/L H₂SO₄ solution. This corresponds to 3.51 mol of acid. This is an amount of an acidic solution suitable for dissolving at least 50% of all metallic elements except Fe and corresponds to the stoichiometric amount suitable for dissolving 98% of all metallic elements except 50% of the Fe. This can be directly derived from Table 4b.

TABLE 4b
Determination of the stoichiometric
amount of sulfuric acid

| | Mass | | Stoichiometric |
|---|---|---|---|
| Element | (g) | Mol | H₂SO₄ (mol) |
| Co | 95 | 1.6 | 1.6 |
| Ni | 23 | 0.4 | 0.4 |
| Mn | 6 | 0.1 | 0.1 |
| Cu | 55 | 0.9 | 0.9 |
| Fe | 68 | 1.2 | 1.2 |

This example shows that a pH controlled acid supply can be used to add an amount of acid that is stoichiometric to dissolve at least 50% of all metallic elements except Fe and at most 100% of said metallic elements, plus 50% of the Fe. As a result, nearly all Co, Ni, Mn and Cu is dissolved while 64% of the Fe reports to the residue. The residue contains only small amounts of the most valuable metals Co and Ni.

In comparison with examples 1, 2 and 3, the outcome of this example is less favorable, for two reasons. Firstly the pH of the product solution equals 1.4, which is lower than the preferred range between 1.5 and 3. The fact that this pH further decreases after the end of acid addition can be explained by the fact that acid is released into the solution during hydrolysis of iron, for example according to the reaction below.

Fe₂(SO₄)₃+4H₂O□2FeOOH(s)+3H₂SO₄

Secondly the Fe concentration in the solution is measured to be 11 g/l, which is much higher than the preferred range between 0.5 and 3 g/l.

We attribute this less favorable outcome to the fact that instead of determining the stoichiometric amount of the acidic solution to dissolve 100% of all metallic elements except Fe first and limiting the acid to maximum 100% of that amount in a first acid addition stage, the use of a pH based controller for acid addition resulted the addition of a larger amount of acid. As a result the system evolved to a less preferred state. This state cannot be corrected anymore by additional acid addition.

### COMPARATIVE EXAMPLE 5

A CoNiCuFeMn-alloy originates from a battery smelting process. It is converted into a powder by atomization. The particle size distribution is measured with laser diffraction: the mean particle diameter has a D50 of 162 μm, and a D90 of 361 μm.

The elemental composition by weight is: 32% Co, 13% Ni, 2.4% Mn, 27% Cu, and 27% Fe.

220 g of this alloyed powder is added to a beaker together with 2 L of demineralized water. Upon mixing, a suspension forms, which is heated to 63° C. 02 is sparged through the suspension at 80 L/h.

830 mL of a 500 g/L H₂SO₄ solution is slowly added to the suspension over a time of 6 h, while sparging. The redox-potential is measured to be 447 mV vs Ag/AgCl and a pH of 1.0 is measured.

Next, the solid and liquid fractions are separated by filtration. 1.9 L of leach solution is obtained. The residue weighs 35.7 g with a moisture content of 67%. Both compositions are in table 5, together with the leach yield that is calculated as the mass of an element contained in the liquid divided by the sum of the amounts of the element contained in the filtrate and the solids.

TABLE 5
Composition of solid residue and leach solution for Example 5

| | Composition | Composition solids | Leach yields |
|---|---|---|---|
| Element | liquid (g/l) | on a dry basis (%) | (%) |
| Co | 37 | 0.72 | >99 |
| Ni | 15 | 2.1 | >99 |
| Mn | 2.7 | 2.2 | 95 |
| Cu | 31 | 1.1 | >99 |
| Fe | 31 | 9.7 | 98 |

This example shows that dosing too much acid results in a nearly full dissolution of all metals, including Fe, which thus end up in the leach solution.

### EXAMPLE 6

This example illustrates an embodiment using hydrochloric acid.

A CoNiCuFeMn-alloy originates from a battery smelting process. It is converted into a powder by atomization. The particle size distribution is measured with laser diffraction: the mean particle diameter has a D50 of 143 μm, and a D90 of 296 μm.

The elemental composition by weight is: 19% Co, 44% Ni, 7.8% Mn, 22% Cu, and 5.8% Fe.

390 g of this alloyed powder is added to a beaker together with 0.85 L of demineralized water. Upon mixing, a suspension forms, which is heated to 60° C. 02 is sparged through the suspension at 75 L/h.

The stoichiometric amount of hydrochloric acid to dissolve all metallic elements except Fe is determined to be 12.2 mol of HCl. This can be directly derived from Table 6a. This corresponds to 1010 mL of an aqueous acidic solution containing 440 g/l HCl.

TABLE 6a
Determination of the stoichiometric amount
of hydrochloric acid for Example 6

| | Mass | | Stoichiometric |
|---|---|---|---|
| Element | (g) | Mol | HCl (mol) |
| Co | 74 | 1.26 | 2.52 |
| Ni | 172 | 2.92 | 5.85 |
| Mn | 30 | 0.55 | 1.11 |
| Cu | 86 | 1.35 | 2.70 |
| Fe | 23 | 0.41 | 0.81 |

It is selected to add 80% of the above-determined amount to the suspension. This corresponds to 810 mL of aqueous acidic solution. The solution is slowly added, over a period of 3 h, while sparging.

The redox-potential is measured to be 315 mV vs Ag/AgCl and the pH is measured to be 2.1.

The temperature is then increased to 80° C., while sparging is continued. After 4 hours the redox-potential is measured to be 559 mV Ag/AgCl and the pH has climbed to 2.3. Liquid is sampled and the Fe concentration is measured to be 0.01 g/L.

The pH is above the threshold of 2: this triggers the need for further acidification according to the pH-related criterion when using hydrochloric acid. A pH between 0.5 and 2 is targeted.

A further amount of aqueous acidic solution is therefore slowly added to the suspension, over a period of 4 h, at a temperature of 80° C. while sparging 02 through the suspension at 75 L/h. The process step is assumed to be terminated when the pH stabilizes at 1.7. A further amount of 140 ml of acidic solution has then been added.

In total 1010 ml of 440 g/l HCl solution has been used. This corresponds to a stoichiometric amount suitable for dissolving 100% of all metallic elements except Fe. This also corresponds to the stoichiometric amount suitable for dissolving 97% of all metallic elements except 50% of the Fe.

Next, the solid and liquid fractions are separated by filtration. 1.6 L of leach solution is obtained. The residue weighs 105 g with a moisture content of 49%. Both compositions are shown in table 6b, together with the leach yield that is calculated as the mass of an element contained in the liquid divided by the sum of the amounts of the element contained in the filtrate and the solids.

TABLE 6b
Composition of solid residue and leach solution for Example 6

| | Composition | Composition solids | Leach yields |
|---|---|---|---|
| Element | liquid (g/l) | on a dry basis (%) | (%) |
| Co | 46 | 0.6 | >99 |
| Ni | 105 | 1.7 | >99 |
| Mn | 18 | 0.6 | 99 |
| Cu | 5.2 | 2 | 99 |
| Fe | 0.04 | 42 | 0.3 |

This example shows how nearly all Co, Ni, Mn and Cu can be dissolved with high yields using hydrochloric acid, while more than 99% of the Fe reports to the residue. The residue contains only traces of the most valuable metals Co and Ni.

1-15. (canceled)

16. A process for the separation of Fe from Cu and one or more of Ni and Co contained in an alloyed powder having more than 1% by weight of Cu, comprising the steps of:
contacting, in oxidizing conditions, the alloyed powder with a stoichiometric amount of an acidic solution selected between a minimum suitable for dissolving 50% of all metallic elements except Fe, and a maximum suitable for dissolving 100% of all metallic elements except 50% of the Fe, thereby obtaining a leach solution containing more than 50 wt % of the Cu and of the one or more of Ni and Co, and a residue containing more than 50 wt % of the Fe; and,
separating the leach solution from the residue;
wherein the contacting step is performed in stages.

17. The process according to claim 16, wherein the alloyed powder originates from the recycling of Li-ion batteries or their waste using a pyrometallurgical smelting process.

18. The process according to claim 16, wherein the alloyed powder is obtained by comminution or atomization.

19. The process according to claim 16, wherein the alloyed powder has a particle size distribution having a D90 below 800 m, and/or a D50 below 300 m, wherein the distribution is by number, and wherein the particle size distribution is determined by laser diffraction according to ISO 13320:2020.

20. The process according to claim 16, wherein the acid in the acidic solution is either H₂SO₄ or HCl.

21. The process according to claim 16, wherein the contacting step is performed in stages according to:
mixing the alloyed powder with a first amount of acidic solution, corresponding to 50% to 95% of the selected stoichiometric amount, thereby obtaining a suspension comprising a liquid phase and a solid phase;
oxidizing the suspension; and,
acidifying the suspension with a second amount of acidic solution, whereby the sum of said first and second amount corresponds to 100% of the determined stoichiometric amount.

22. The process according to claim 16, wherein the acid in the acidic solution is H₂SO₄, and wherein the contacting step is performed in stages according to:
determining a stoichiometric amount of the acidic solution to dissolve 100% of all metallic elements except Fe;
mixing the alloyed powder with an amount of the acidic solution corresponding to 50% to 100% of the determined stoichiometric amount, thereby obtaining a suspension comprising a liquid phase and a solid phase;
oxidizing the suspension at a temperature of more than 50° C. to a redox potential of more than 320 mV Ag/AgCl;
with the proviso that the Fe concentration in the liquid phase is below 0.5 g/L, acidifying the suspension at a temperature of more than 50° C. in oxidizing conditions by adding acidic solution until the Fe concentration is between 0.5 g/L and 3 g/L; and
with the proviso that the pH of the liquid phase is above 3, acidifying the suspension at a temperature of more than 50° C. in oxidizing conditions by adding acidic solution until the pH is between 1.5 and 3.

23. The process according to claim 16, wherein the acid in the acidic solution is HCl, and wherein the contacting step is performed in stages according to:
determining a stoichiometric amount of the acidic solution according to claim 16;
mixing the alloyed powder with an amount of the acidic solution corresponding to 50% to 95% of the determined stoichiometric amount, thereby obtaining a suspension comprising a liquid phase and a solid phase;
oxidizing the suspension at a temperature of more than 50° C. to a redox potential of more than 320 mV Ag/AgCl; and,
with the proviso that the pH of the liquid phase is above 2, acidifying the suspension at a temperature of more than 50° C. in oxidizing conditions by adding acidic solution until the pH is between 0.5 and 2.

24. The process according to claim 16, wherein the oxidizing conditions in the contacting step are obtained by addition of H₂O₂ and/or an O₂-bearing gas.

25. The process according to claim 16, wherein the process is performed at atmospheric pressure.

26. The process according to claim 16, wherein the acidic solution in the contacting step is obtained by acidic leaching of a solid starting material containing Ni and/or Co.

27. The process according to claim 26, wherein the alloyed powder and the solid starting material have the same composition.

28. The process according to claim 21, wherein the steps of mixing, oxidizing, and acidifying are operated sequentially as continuous processes.

29. The process according to claim 16, wherein the leach solution, obtained in the step of separating the leach solution from the residue, is further treated in an electrowinning step to separate Cu from other metals contained in said solution, particularly from Ni and/or Co.

30. The process according to claim 29, wherein the leach solution, obtained in the step of separating the leach solution from the residue, is further treated in an electrowinning step to separate Cu from Ni and/or Co contained in said solution.
